(19) United States
(12) Patent Application Publication
(10) Pub. No.: US 2004/0039850 A1
(43) Pub. Date: Feb. 26, 2004

(54) Apparatus and method for automatically configuring network media connection

(75) Inventors: Jin-Ru Chen, TaiChung (TW); Jiam-Shiun Tung, TaiChung (TW); Delta Hsu, Hsinchu (TW)

Correspondence Address: BRUCE H. TROXELL, SUITE 1404, 5205 LEESBURGH PIKE, FALLS CHURCH, VA, 22041, US

(73) Assignee: Realtek Semiconductor Corp.

(21) Appl. No.: 10/640,033

(22) Filed: Aug. 14, 2003

(30) Foreign Application Priority Data
Aug. 20, 2002 (TW) 91118735

(51) Int. Cl. G06F 3/00

(52) U.S. Cl. 710/1

(57) ABSTRACT

The present invention provides an apparatus for automatically configuring media connection of a first node device in a network, wherein the first node device and a second node device connected to the first node device both have at least a first pair and a second pair of connectors for transceiving data, the apparatus comprising a switch device, switching the configuration of the connectors in response to a control signal or an inhibiting signal, wherein the first and second pair of connectors of the first node device are connected to the first and second pair of connectors of the second node device respectively when the connectors are in the first configuration and the first and second pair of connectors of the first node device are connected to the second and first pair of connectors of the second node device respectively when the connectors are in the second configuration; a control signal generator, generating the control signal for controlling the switch device according to a random value comprising a plurality of bits, wherein each bit of the random value is shifted periodically and in a circular manner; and a processing logic, generating the inhibiting signal in response to the link signal which represents the connecting status of the first and the second node device, wherein the inhibiting signal is for preventing the switch device from switching.

### BACKGROUND OF THE INVENTION

(a). Field of the Invention

The present invention relates in general to a network system, and more particularly to an apparatus and method for automatically configuring network media connection.

(b). Description of the Prior Arts

Nowadays Ethernet is one of the most prevailing LAN technologies. 10 Base-T and 100 Base-TX, which are common Ethernet technologies, employ the twisted pair cable as the media between two node devices. In the network using the twisted pair cable as connection media, one or more pairs of conductors are used to transmit data, and another one or more pairs of conductors are used to receive data. A node device connects to the conductors by a connector including multiple pins. The media connection between the pins and the conductor is called media dependent interface (MDI). The two node devices are connected by connecting the pins for reception/transmission of the connector of one of the node devices to the pins for transmission/reception of the connector of another node device. Based on this requirement, there are different media connection configurations for different kinds of node device, such as a network interface card (NIC) used as an end node device and a repeater or network switch used as an intermediate node device.

FIG. 1 is a diagram showing the MDI used in RJ-45 connectors. As shown in FIG. 1, RJ-45 connectors are used in 100 Base-TX Ethernet. For a NIC, the pins 1 and 2 are assigned as the transmit pair, while the pins 3 and 6 are assigned as the receive pair. To meet the requirement mentioned above, the media connection configuration of a repeater, hub, or switch connected to the NIC is opposite to the NIC, that is, the pins 3 and 6 are assigned as the transmit pair, and the pins 1 and 2 are assigned as the receive pair. The configuration of the NIC in FIG. 1 is commonly referred to as MDI, while the configuration of the hub in FIG. 1 is referred to as MDIX (media dependent interface crossover).

However, in the LAN, it is not always that a NIC is connected directly to a hub. A NIC may be connected directly to another NIC, aid the hub may be connected directly to another hub as well. Thus, there is a need for the function of automatic-configuring the MDI configuration according to the configuration of the connected device. This function enables a node to automatically configure its own media connector to match the MDI configuration of another connected node, i.e. the receive/transmit channel of one node is exactly the transmit/receive channel of the other node.

However, when the automatic-configuring MDI module and an auto-negotiation module operate simultaneously, the situation that unable to establish a media connection between two node devices may happen under certain circumstances. The auto-negotiation here refers to the function disclosed in IEEE 802.3u that enables an Ethernet hub/switch and a connected device to negotiate an optimal operation mode supported by both sides, such as data rates (10 Mbps or 100 Mbps) and Full/Half Duplex. When a device enables the automatic-configuring module and the auto-negotiation module simultaneously while the data rate is 100 Mbps, the auto-negotiation module would start parallel detection and pause to send continuous IDLE codes. This would cause the device to switch between MDI and MDIX configurations automatically even when the MDI configurations of two connecting node devices match. Thus, auto-negotiation would fail, and a linkage between two node devices cannot be established.

### SUMMARY OF THE INVENTION

In view of this problem, the object of the present invention is to provide an apparatus for automatically configuring media connection of a first node device in a network, wherein the first node device and a second node device connected to the first node device both have at least a first pair and a second pair of connectors for transceiving data, the apparatus comprising a switch device, switching the configuration of the connectors in response to a control signal or an inhibiting signal, wherein the first and second pair of connectors of the first node device are connected to the first and second pair of connectors of the second node device respectively when the connectors are in the first configuration and the first and second pair of connectors of the first node device are connected to the second and first pair of connectors of the second node device respectively when the connectors are in the second configuration; a control signal generator, generating the control signal for controlling the switch device according to a random value comprising a plurality of bits, wherein each bit of the random value is shifted periodically and in a circular manner; and a processing logic, generating the inhibiting signal in response to the link signal which represents the connecting status of the first and the second node device, wherein the inhibiting signal is for preventing the switch device from switching.

The present invention also provides a method for automatically configuring media connection of a first node device and a second node device in a network, wherein the first node device and the second node device both have a first and a second pair of connectors for transceiving data the method comprising the steps of selectively switching the configuration of the connectors of the first node device according to a control signal or an inhibiting signal, wherein the first and second pair of connectors of the first node device are connected to the first and second pair of connectors of the second node device respectively when the connectors are in the first configuration and the first and second pair of connectors of the first node device are connected to the second and first pair of connectors of the second node device respectively when the connectors are in the second configuration; suspending the selected configuration for The pause time period when the first node device receives an IDLE code from the second node device; generating the inhibiting signal when receiving a link signal from the second node device, wherein the inhibiting signal is for preventing the connectors from configuration switching; and generating the control signal when not receiving the link signal from the second node device, wherein the control signal is for controlling the configuration switching of the connectors.

Another object of the present invention is to provide a method for automatically configuring media connectors of the first node device in the network using the above apparatus. The method includes selectively switching connections between the pairs of connectors and the pairs of conductors according to the control signal and the inhibiting signal, and determining a period of pause time. The method also includes suspending the selective switching for the period of pause time when the first node device receives an IDLE code. The method also includes generating the inhibiting signal or c hanging the control signal according to a link signal from the second node device. The inhibiting signal is generated to indefinitely prevent the selective switching.

### BRIEF DESCRIPTION OF THE DRAWINGS

FIG. 1 is a diagram showing the MDI used in a RJ-45 connector.

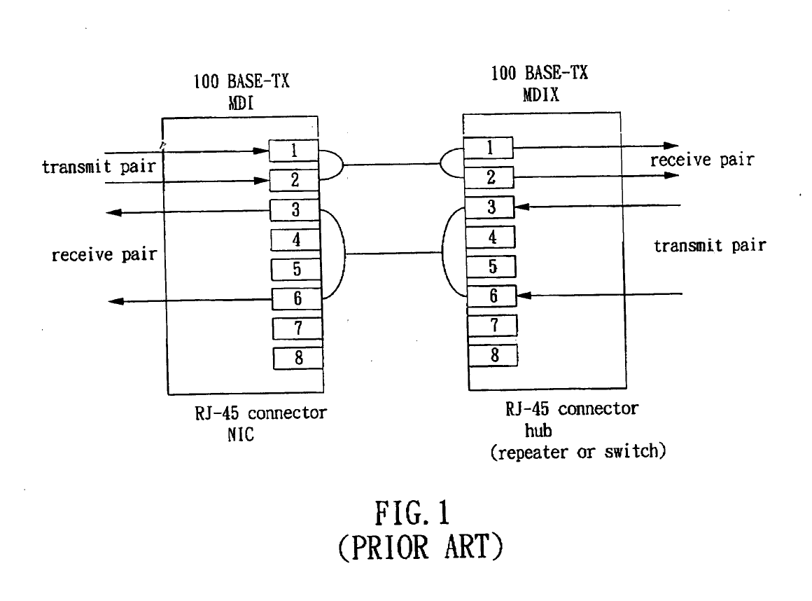

FIG. 2 is a block diagram of an apparatus for automatically configuring network media connection according to the embodiment of the present invention.

FIG. 3 is a block diagram of a conventional media-configuring module.

FIG. 4 is a block diagram of the media-configuring module according to the embodiment of the present invention.

FIG. 5 is a flow chart of the method for automatically configuring network media connection according to the embodiment of the present invention.

### DETAILED DESCRIPTION OF THE PRESENT INVENTION

This section will provide a detailed description and appended drawings to better understand the goals and features of the embodiments of the present invention. Although the Ethernet MDI/MDIX is disclosed in the following embodiments, the present invention is not limited thereby.

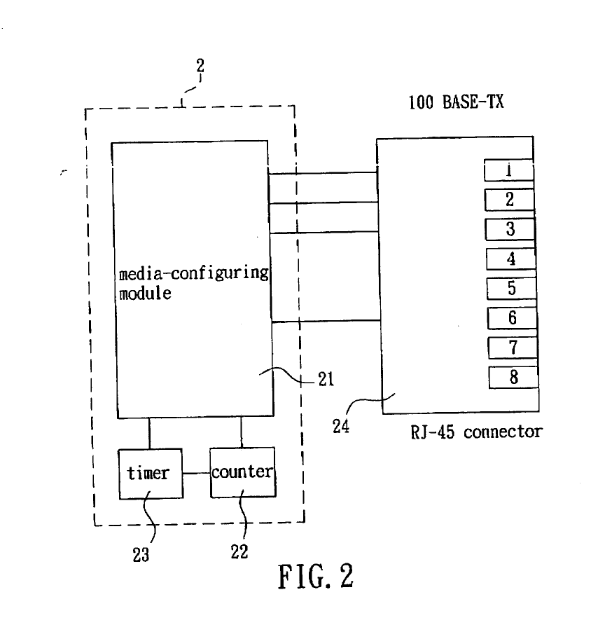

FIG. 2 is a block diagram of an apparatus 2 for automatically configuring network media connection according to the embodiments of the present invention. The apparatus 2 can be used to automatically configure media connector of a node device in an Ethernet network. The apparatus 2 includes a media-configuring module 21 for selectively switching between MDI and MDIX configurations of the node device, and suspending for a pause time period when receiving an IDLE code. The apparatus 2 also includes a variable pause time generator coupled to the media-configuring module 21 for adjusting a pause time period and outputting lie pause time. In an embodiment, the variable pause time generator comprises a counter 22 having a predetermined default value and configuring to add a first value if the media-configuring module 21 does not receive a link signal after the period of pause time, The variable pause time generator also includes a timer 23 coupled to the counter 22. The timer 23 configures the period of pause time according to the value stored in the counter 22.

The present invention makes use of the variable pause time generator to dynamically adjust the period of pause time. The counter 22 records the number of failure of parallel detection, that is, the connection cannot be established after entering parallel detection for the period of pause time, and uses this number to adjust the timer 23. In an embodiment, the initial value of the counter 22 is 0, and the first value is 1. If parallel detection fails, it would make the media-configuring module 21 unable to receive any link signal. Thus, after the period of pause time is ended and the media-configuring module 21 restores to work, if the media-configuring module 21 does not receive any link signal after the period of pause time, it means that parallel detection is still not finished and the counter 22 is increased by one to extend the period of pause time. Here the link signal refers to the signal for indicating the establishment of a connection. The format of the link signal depends on the protocol of Ethernet technology. The more the number of failures accumulates, the longer the period of pause time is extended. Thus, there is more time allowed for accomplishing parallel detection.

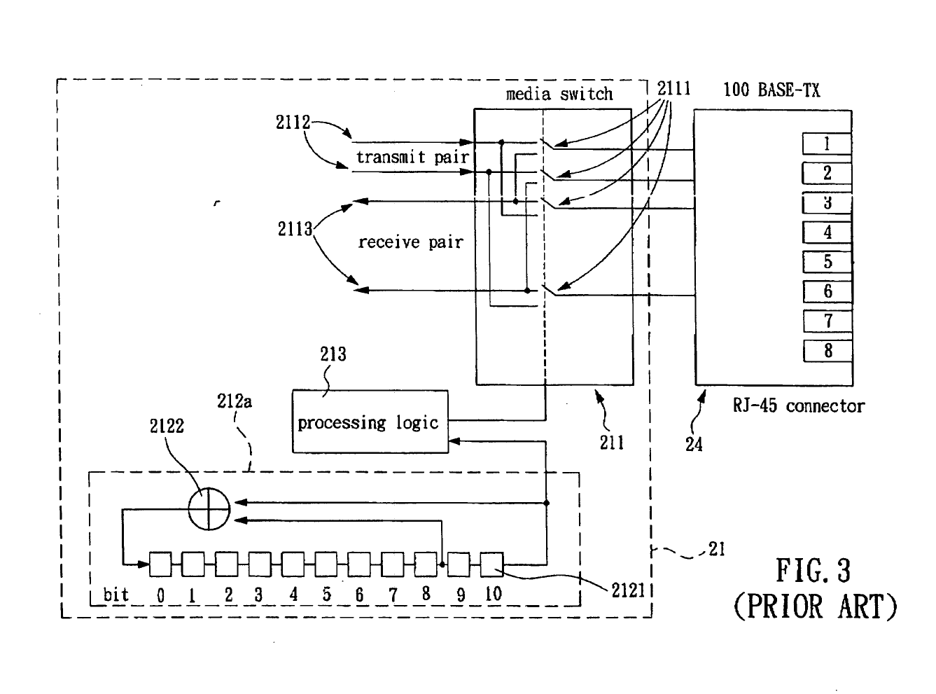

The detail description of the automatic MDI/MDIX configuration can refer to the IEEE Std 802.3. In the U.S. Pat. No. 6,175,865, the conventional media-configuring module 21 comprises a media switch 211, a control signal generator 212a, and a processing logic 213 coupled to the media switch 211 and the control signal generator 212a, as shown in FIG. 3. The control signal generator 212a generates the control signal in a pseudo-random manner to avoid two network devices switching MDI/MDIX configurations simultaneously.

In the present invention, two preferred embodiments of the media-configuring module 21 are provided. In the first embodiment, the register 2121 is used and the value of the register 2121 is stored in a circular manner. In the second embodiment, a third configuration is added to avoid configuration switching simultaneously.

### First Embodiment

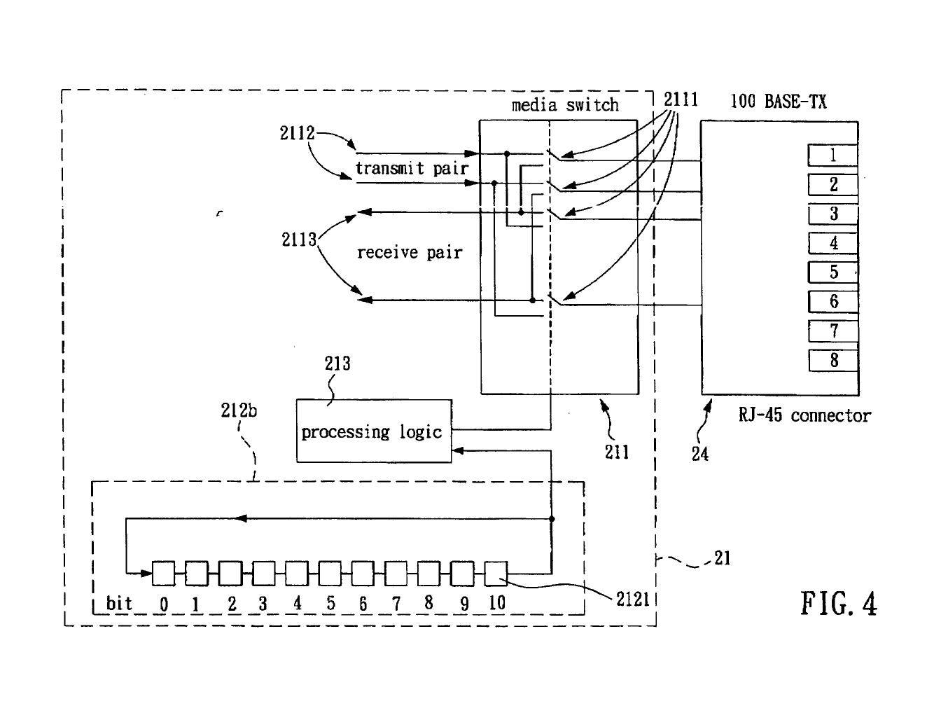

FIG. 4 is a block diagram of the media-configuring module 21 according to the first embodiment of the present invention. In FIG. 4, the adder 2122 of FIG. 3 is discarded and the highest bit of the register 2121 is fed back into the lowest bit and also provided to the processing logic 213. A counter is added in this embodiment and the value of the counter is determined based on a RC time constant of a power-on reset of the network device. This value is counted by a counter and at least a part of this value is written into the register 2121 when the network device is powered on. The RC time constant of each node device is substantially different from each other at least due to process variation, the physical properties of the device, and/or the environmental properties, such as temperature, and this makes the value of different counters are different. Therefore, the initial value of the register 2121 of any two connected devices are different after power-on or reset, thereby preventing the two devices switching simultaneously. The register 2121 comprises a linear feedback shift register to shift the value of each bit stored in the register 2121 periodically and in a circular manner. That is, the value of the first bit of the register 2121 in this time period is the value of the last bit of the register 2121 in next time period. Thus, the media switch 211 switches the configuration according to the corresponding bit value stored in the register 2121.

### Second Embodiment

In addition to the MDI and MDIX configurations, a third configuration is added in the second embodiment, that is, the receive and transmit channels pause the operation simultaneously such that signals in the channels can be cleared to avoid signal overlapping during switching.

In practical, the contact 2111 of the media switch 211 doesn't connect to any pins of the RJ-45 connector 24 in the third configuration. The control signal is configured to include two bit values since three configurations are used. The correspondence between the configurations and bit values is not limited. For example, “01” may correspond to the MDI configuration, “10” corresponds to the MDIX configuration, “00” corresponds to the third configuration, and “11” is to maintain the original configuration, not for switching.

The control signal generator 212b of FIG. 4 generates the control signal, either in the pseudo-random way disclosed in the IEEE Std 802.3 or the way disclosed in the first embodiment. The processing logic 213 needs a corresponding modification to incorporate the third configuration.

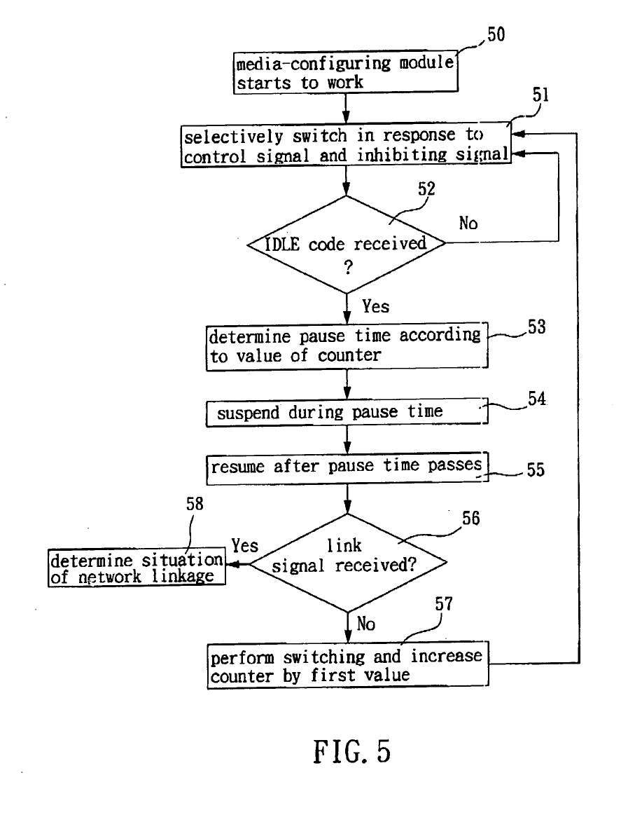

FIG. 5 is a flow chart of the method for automatically configuring network media connections according to the present invention. As shown in FIG. 5, the flow chart comprises steps of:

50 starting the operation of the media-configuring module 21;

51 selectively switching the configuration in response to a control signal and an inhibiting signal;

52 whether an IDLE code is received, if no, back to the step 51;

53 determining a period of pause time according to the value of the counter 22;

54 suspending the operation of the media-configuring module 21 during the period of pause time;

55 resuming the operation of the media-configuring module 21 after the period of pause time;

56 whether a link signal is received, if yes, back to the step 58;

57 performing the configuration switching, increasing the counter 22 by a first value, and returning to the step 51; and

58 determining the situation of the network linkage.

Here the media connectors may have the MDI and MDIX configurations, or may further have the third configuration as disclosed in the second embodiment. In the step 50, the counter 22 ha& an initial value when starting the operation of the media-configuring module 21. For simplicity, the initial value is set to be 0, and the first value of the step 57 is set to be 1. In the step 51, the way to generate and employ the control signal and the inhibiting signal is not limited.

When the network linkage is determined as operating normally in the step 58, the inhibiting signal is sustained to prevent configuration switching since the media-configuring module 21 continues receiving a link signal. If the cable is unplugged to break the linkage, the media-configuring module 21 will disable the inhibiting signal to resume the configuration switching since not receiving a link signal. In an embodiment, a timer is added into the apparatus 2 to generate a reset signal, which can be used to reset the media-configuring module 21 after the linkage is broken for a specific period of time.

While the present invention has been shown and described with reference to two preferred embodiments thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. An apparatus for automatically configuring media connection of a first node device in a network, wherein the first node device and a second node device connected to the first node device both have at least a first pair and a second pair of connectors for transceiving data, the apparatus comprising:
a switch device, switching the configuration of the connectors in response to a control signal and an inhibiting signal, wherein the first and second pair of connectors of the first node device are connected to the first and second pair of connectors of the second node device respectively when the connectors are in the first configuration and the first and second pair of connectors of the first node device are connected to the second and first pair of connectors of the second node device respectively when the connectors are in the second configuration;
a control signal generator, generating the control signal for controlling the switch device according to a random value comprising a plurality of bits, wherein each bit of the random value is shifted periodically and in a circular manner; and
a processing logic, generating the inhibiting signal in response to a link signal which represents the connecting status of tile first and the second node device, wherein the inhibiting signal is for preventing the switch device from switching.

2. The apparatus of claim 1, wherein the random value corresponds to a RC time constant.

3. The apparatus of claim 2, wherein the control signal generator further comprises a counter for counting the RC time constant.

4. The apparatus of claim 3, wherein the control signal generator comprises a shift register for storing the counting RC time constant as the random value.

5. The apparatus of claim 1, further comprising:
a reset timer for generating a reset signal being used to reset the apparatus after the linkage is broken for a predetermined time period.

6. The apparatus of claim 1, wherein the first node device comprises a network interface card (NIC) having a Media Dependent Interface.

7. The apparatus of claim 1, wherein the first node device (MDI) comprises a repeater or a switch having a Media Dependent Interface Crossover (MDIX).

8. The apparatus of claim 1, wherein the apparatus further comprises a variable pause time generator for suspending a pause time period when receiving an IDLE code.

9. The apparatus of claim 1, wherein when the connectors of the first node device are in a third configuration in response to the control signal, the first and second pair of connectors of the first node device are disconnected from the first and second pair of conductors of the second node device.

10. An apparatus for automatically configuring media connection of a first node device in a network, wherein the first node device and a second node device connected to the first node device both have at least a pair of connectors for transceiving data, the apparatus comprising:
a media-configuring module, for selectively switching configurations between the pair of connectors of the first node device and that of the second node device, and suspending operation for a pause time period in response to an IDLE code received from the second node device; and
a variable pause time generator, coupled to the media-configuring module for adjusting the pause time period according to a link signal received from the second node device.

11. The apparatus of claim 10, wherein the variable pause time generator comprises:
a timer for configuring the pause time period according to a counting value; and
a counter coupled to the timer for outputting the counting value, wherein the counting value is increased by a third value if the media-configuring module does not receive the link signal from the second node device after the pause time period.

12. The apparatus of claim 10, further comprising:
a reset timer for generating a reset signal for resetting the apparatus after the linkage is broken for a predetermined time period.

13. The apparatus of claim 10, wherein the media-configuring module comprises:
a switch device, switching the configuration of the connectors in response to a control signal and an inhibiting signal, wherein the first and second pair of connectors of the first node device are connected to the first and second pair of connectors of the second node device respectively when the connectors are in the first configuration and the first and second pair of connectors of the first node device are connected to the second and first pair of connectors of the second node device respectively when the connectors are in the second configuration;
a control signal generator, generating the control signal for controlling the switch device; and
a processing logic, generating the inhibiting signal in response to the link signal which represents the connecting status of the first and the second node device, wherein the inhibiting signal is for preventing the switch device from switching.

14. The apparatus of claim 13, wherein when the connectors of the first node device are in a third configuration in response to the control signal, the first and second pair of connectors of the first node device are disconnected from the first and second pair of conductors of the second node device.

15. The apparatus of claim 10, wherein the first node device comprises a network interface card (NIC) having a Media Dependent Interface.

16. The apparatus of claim 10, wherein the first node device (MDI) comprises a repeater or a switch having a Media Dependent Interface Crossover (MDIX).

17. A method for automatically configuring media connection of a first node device and a second node device in a network, wherein the first node device and the second node device both have a first and a second pair of connectors for transceiving data the method comprising:
selectively switching the configuration of the connectors of the first node device according to a control signal and an inhibiting signal, wherein the first and second pair of connectors of the first node device are connected to the first and second pair of connectors of the second node device respectively when the connectors are in the first configuration and the first and second pair of connectors of the first node device are connected to the second and first pair of connectors of the second node device respectively when the connectors are in the second configuration;
suspending the selected configuration for a pause time period when the first node device receives an IDLE code from the second node device;
generating the inhibiting signal when receiving a link signal, wherein the inhibiting signal is for preventing the connectors from configuration switching; and
generating the control signal when not receiving the link signal, wherein the control signal is for controlling the configuration switching of the connectors.

18. The method of claim 17, further comprising:
adjusting the pause time period according to the link signal.

19. The method of claim 17, wherein the first configuration and the second configuration are a MDI configuration and a MDIX configuration respectively.

20. The method of claim 17, wherein when the connectors are in a third configuration, the pairs of connectors of the first node device are disconnected from that of the second node device.
